(19) United States
(12) Patent Application Publication
(10) Pub. No.: US 2014/0244894 A1
(43) Pub. Date: Aug. 28, 2014

(54) MICROPROCESSOR

(71) Applicant: KABUSHIKI KAISHA TOSHIBA, Minato-ku (JP)

(72) Inventors: Hiroshi Sato, Kanagawa-ken (JP); Hideyuki Yamakawa, Kanagawa-ken (JP)

(73) Assignee: KABUSHIKI KAISHA TOSHIBA, Minato-ku (JP)

(21) Appl. No.: 13/975,911

(22) Filed: Aug. 26, 2013

(30) Foreign Application Priority Data
Feb. 22, 2013 (JP) 2013-033317

(51) Int. Cl. G06F 12/02

(52) U.S. Cl. CPC G06F 12/0238
USPC 711/102

(57) ABSTRACT

According to an embodiment, the program memory stores application software in a ROM area. An address range of the application software targeted for restriction on use in the program memory is described in the application information memory. Yes-or-no information on the use of the application software targeted for restriction on use is written in the yes-or-no information memory. The switch switches between whether or not to apply an input signal to the processor core. The judgment unit judges whether or not a program counter value of the processor core is within the address range described in the application information memory and, when the program counter value is within the address range, the judgment unit controls the switching of the switch based on the yes-or-no information written in the yes-or-no information memory.

### CROSS REFERENCE TO RELATED APPLICATION

This application is based upon and claims the benefit of priority from the prior Japanese Patent Application No. 2013-033317, filed on Feb. 22, 2013, the entire contents of which are incorporated herein by reference.

### FIELD

The embodiments described herein relate to a microprocessor.

### BACKGROUND

There is a microprocessor, including a processor core for which a user can design a program, and a ROM where the program is stored, that can modify the program on the ROM by a ROM correction function.

Application software (hereinafter referred to as application) provided by a manufacturer may be previously written in the ROM. In such a case, restriction on use in accordance with a license of the application is required.

There is as a method for restricting the use, the method for preparing a program to process a restriction on the use of an application and setting permission/non-permission for the use of the application. The manufacturer performs the setting to give “non-permission” for the use of the application to a user who is not permitted to use the application.

However, if the ROM correction function is abused, it is possible to alter the program to process the restriction on the use of the application and disable the use restriction setting itself. Consequently, there arises a problem that the use-restricted application is misapplied.

### BRIEF DESCRIPTION OF THE DRAWINGS

FIG. 1 is a block diagram showing a configuration of a microprocessor according to an embodiment;

FIG. 2 is a diagram showing an arrangement example of application software on a program memory of the microprocessor according to the embodiment, and a relationship with yes-or-no information written in a yes-or-no information memory;

FIG. 3 is an exemplary diagram showing descriptions of an application information memory of the microprocessor according to the embodiment;

FIG. 4 is an exemplary diagram showing the writing of the yes-or-no information memory of the microprocessor according to the embodiment;

FIG. 5 is a flow diagram showing a flow of processes of a judgment unit of the microprocessor according to the embodiment; and

FIGS. 6A, 6B are exemplary diagrams showing a method of unauthorized use of application software, where a ROM correction function is abused.

### DETAILED DESCRIPTION

According to an embodiment, a microprocessor includes a processor core, a program memory, an application information memory, a yes-or-no information memory, a switch, and a judgment unit. The program memory stores application software in a ROM area. An address range of the application software targeted for restriction on use in the program memory is described in the application information memory. Yes-or-no information on the use of the application software targeted for restriction on use is written in the yes-or-no information memory. The switch switches between whether or not to apply an input signal to the processor core. The judgment unit judges whether or not a program counter value of the processor core is within the address range described in the application information memory and, when the program counter value is within the address range, the judgment unit controls the switching of the switch based on the yes-or-no information written in the yes-or-no information memory.

Hereinafter, a plurality of embodiments will be described with reference to the drawings. In the drawings, the same reference numerals denote the same or similar parts.

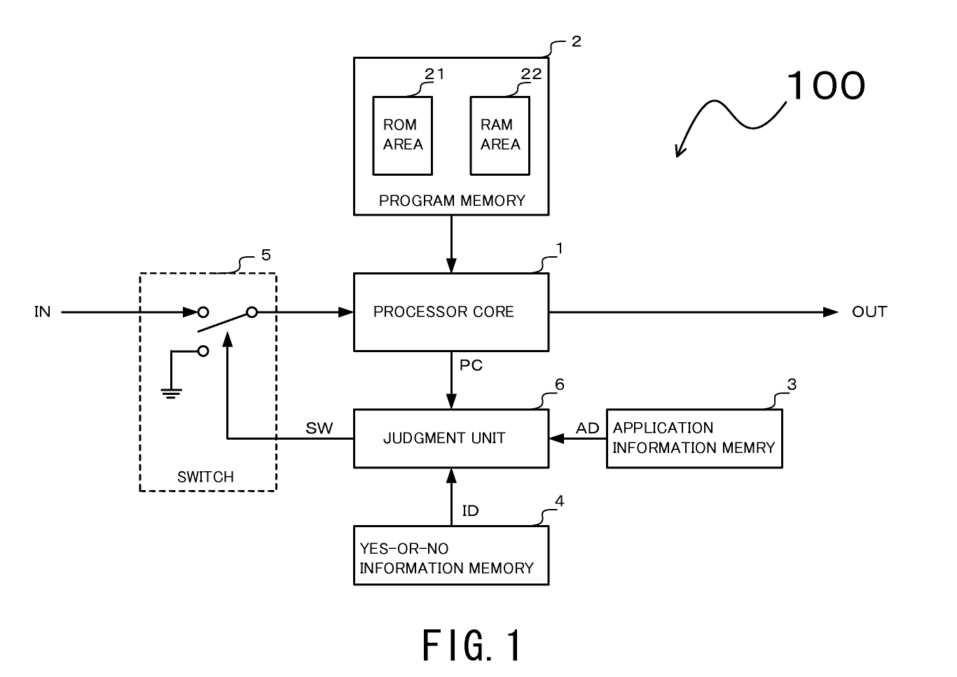

A microprocessor according to a first embodiment will be described with reference to the drawings. FIG. 1 is a block diagram showing a configuration of a microprocessor according to the first embodiment.

As shown in FIG. 1, a microprocessor 100 includes a processor core 1, a program memory 2, an application information memory 3, a yes-or-no information memory 4, and a switch 5.

The program memory 2 includes a ROM area 21 and a RAM area 22. Programs such as application software (hereinafter referred to as application) are stored in the ROM area 21.

The processor core 1 has a ROM correction function that can modify the program in the ROM area 21. When a ROM correction is performed, program data for modification is stored in the RAM area 22.

Some applications to be stored in the ROM area 21 are restricted on use in terms of licenses. Use-restricted applications need the setting of permission/non-permission for the use of the program for each user.

Therefore, an address range AD of an application targeted for restriction on use in the program memory 2 is described in the application information memory 3.

A yes-or-no information ID regarding the use of the application targeted for restriction on use is written in the yes-or-no information memory 4. The application information memory 3 and the yes-or-no information memory 4 have a structure where a user cannot write.

The judgment unit 6 controls the switching of the switch 5 based on the address range AD read out from the application information memory 3 and the yes-or-no information ID read out from the yes-or-no information memory 4.

The switch 5 is a switch that switches between whether or not to apply an input signal IN to the processor core 1.

The judgment unit 6 judges whether or not a program counter value PC of the processor core 1 is within the address range AD read out from the application information memory 3. When the program counter value PC is within the address range AD, the judgment unit 6 reads out the yes-or-no information ID from the yes-or-no information memory 4.

When the yes-or-no information ID indicates “permission,” the judgment unit 6 controls the switch 5 so as to apply the input signal IN to the processor core 1.

On the other hand, when the yes-or-no information ID indicates “non-permission,” the judgment unit 6 switches the switch 5 so as not to apply the input signal IN to the processor core 1. As shown in FIG. 1, a ground potential (‘0’) is input into the processor core 1. When the input signal IN is an audio signal, for example, input into the processor core 1 becomes in an an acoustic state.

Consequently, even if the application that has given non-permission for use is executed, normal output cannot be obtained from the processor core 1, and the application becomes substantially unusable.

Three types of memories, the program memory 2, the application information memory 3, and the yes-or-no information memory 4, are used here. Of them, the user can control and change only the RAM area 22 of the program memory 2.

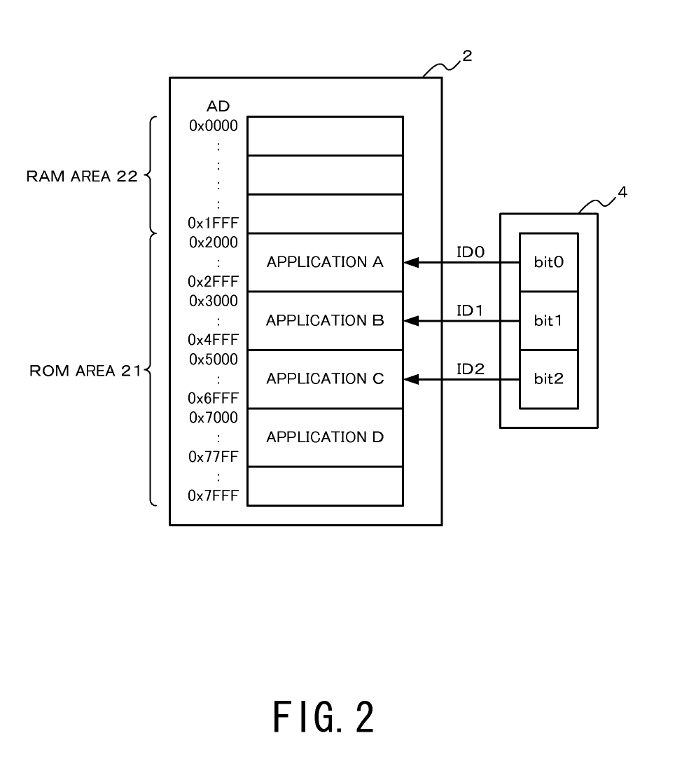

FIG. 2 shows an arrangement example of applications on the program memory 2 and a relationship with yes-or-no information IDs written in the yes-or-no information memory 4.

As shown in FIG. 2, an application A, an application B, an application C, and an application D are arranged in the ROM area 21 of the program memory 2. With regard to the address range AD, the application A has 0x0000 to 0x2FFF, the application B has 0x3000 to 0x4FFF, the application C has 0x5000 to 0x6FFF, and the application D has 0x7000 to 0x77FF.

Out of the applications, the applications A, B, C are targeted for restriction on use, and the application D is not targeted.

The yes-or-no information IDs are written in the yes-or-no information memory 4 for each of the applications A, B, C targeted for restriction on use.

Assume that the yes-or-no information ID is one-bit data, and that three-bit information is written in the yes-or-no information memory 4. In other words, assuming that the bit numbers of the three bits are assumed to be bit0, bit1, and bit2, a yes-or-no information ID0 for the application A is written in bit0, a yes-or-no information ID1 for the application B in bit 1, and a yes-or-no information ID2 for the application C in bit2.

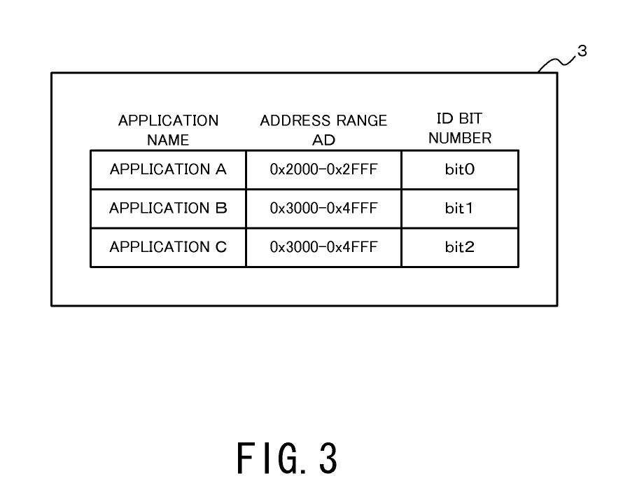

FIG. 3 is a description example of the application information memory 3 for the applications A, B, C targeted for restriction on use.

As shown in FIG. 3, the address ranges AD in the program memory 2 and the bit numbers of the yes-or-no information memory 4 are described for the applications targeted for restriction on use in the application information memory 3.

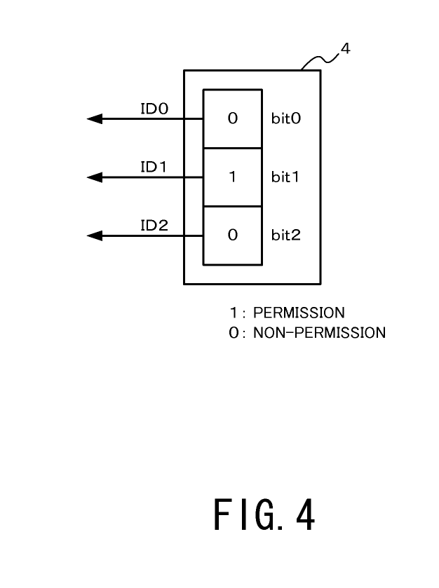

FIG. 4 is a writing example of the yes-or-no information memory 4.

With regard to a one-bit yes-or-no information ID, it is assumed here that the bit number ‘1’ represents “permission” and the bit number ‘0’ represents “non-permission.”

When the applications A, C are “non-permission” and the application B is “permission,” for example, bit0=0, bit1=1, and bit2=0 are written in the yes-or-no information memory 4.

The values of bit0, bit1, and bit2 are the yes-or-no information ID0 for the application A, the yes-or-no information ID1 for the application B, and the yes-or-no information ID2 for the application C, respectively.

The number of bits of the yes-or-no information memory 4 is not limited to three bits. It is preferred that the number of bits increase or decrease depending on the number of applications targeted for restriction on use.

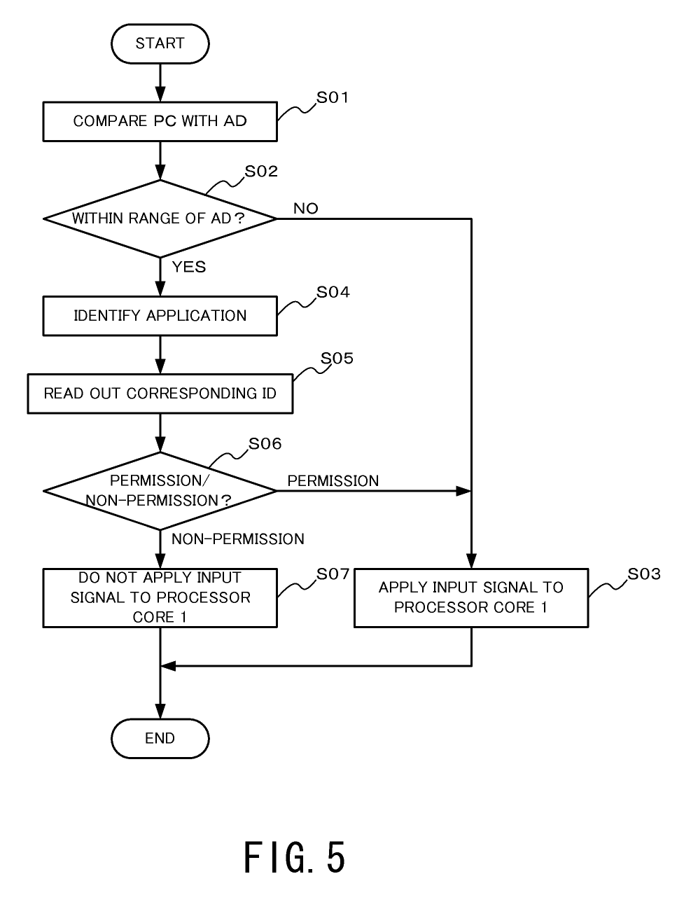

FIG. 5 is a flow diagram showing an example of a flow of processes of the judgment unit 6. In the flow shown here, the processes of the judgment unit 6 are performed as described below.

The judgment unit 6 receives the program counter value PC of an instruction being executed from the processor core 1, and compares the program counter value PC with the address range AD of an application targeted for restriction on use, the address range AD being described in the application information memory 3 (Step S01). The judgment unit 6 judges whether or not the program counter value PC is within the address range AD of the application targeted for restriction on use (Step S02).

When judging that the program counter value PC is outside the address ranges AD of all the applications targeted for restriction on use (NO), the judgment unit 6 controls the switch 5 and applies the input signal IN to the processor core 1 (Step S03).

On the other hand, when judging that the program counter value PC is within the address range AD of the application targeted for restriction on use (YES), the judgment unit 6 identifies a relevant application from the address range AD including the program counter value PC (Step S04).

Next, the judgment unit 6 reads out the bit number of the yes-or-no information ID corresponding to the identified application from the application information memory 3, and reads out the yes-or-no information ID of the bit number from the yes-or-no information memory 4 (Step S05).

Next, the judgment unit 6 judges whether the read yes-or-no information ID is a value representing “permission” or a value representing “non-permission” (Step S06).

At this point, when the yes-or-no information ID is “permission,” the judgment unit 6 controls the switch 5 and applies the input signal IN to the processor core 1 (Step S03).

On the other hand, when the yes-or-no information ID is “non-permission,” the judgment unit 6 controls the switch 5 so as not to apply the input signal IN to the processor core 1 (Step S07).

Even if an application whose yes-or-no information ID is “non-permission” is executed, normal output cannot be obtained from the processor core 1 due to the above processes of the judgment unit 6. The application becomes substantially unusable.

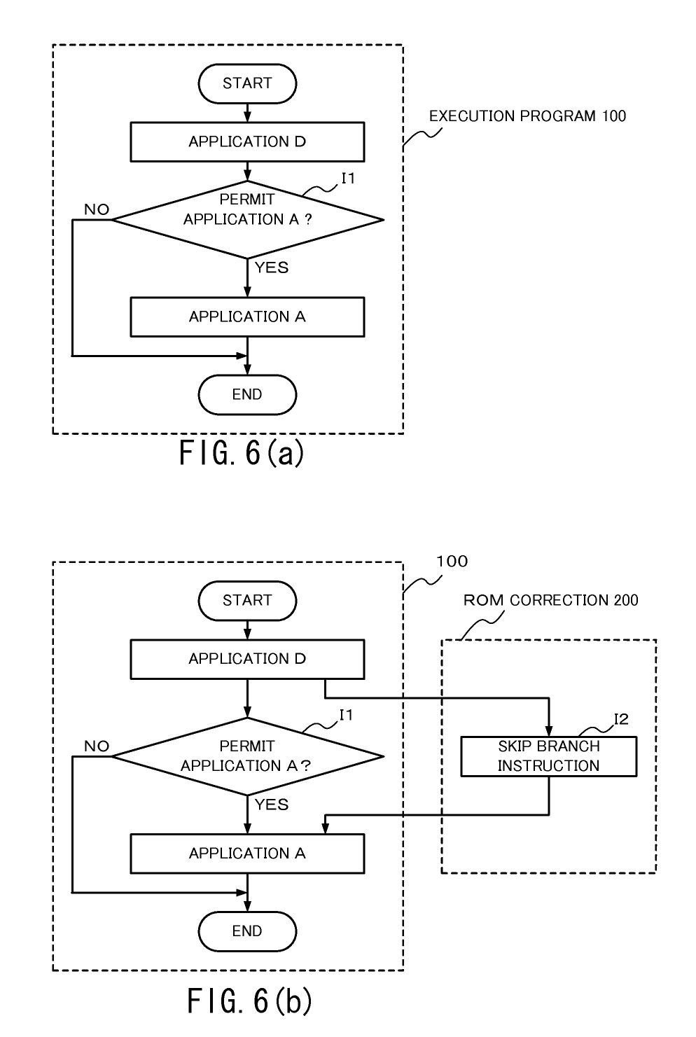

FIGS. 6A, 6B show examples of a method of unauthorized use of application software, where the ROM correction function is abused.

The execution program 100 shown in FIG. 6A is an example of a program in the case where there is no permission for use for the use-restricted application A, the application A cannot be executed due to a branch instruction I1.

In contrast, FIG. 6B is an example where the application A can be executed by abusing the ROM correction function even if there is no permission for use. In this case, an instruction I2 to skip the branch instruction I1 is described in a ROM correction 200.

The application A having no permission for use ends up being executed by the execution of the ROM correction 200 while the execution program 100 is being executed.

However, even if an application having no permission for use is executed in the above-mentioned method in the embodiment, the input signal IN is not applied to the processor core 1 during execution of the application. Therefore, the use of the application is substantially blocked.

As described above, the program memory 2, the application information memory 3, the yes-or-no information memory 4, the switch 5, and the judgment unit 6 are provided in the microprocessor of the embodiment. There is no influence of the ROM correction function on the application information memory 3 and the yes-or-no information memory 4. Permission/non-permission for the use of an application targeted for restriction on use is judged by the application information memory 3, the yes-or-no information memory 4, the switch 5, and the judgment unit 6. Hence, it is possible to protect an application targeted for restriction on use from unauthorized use where the ROM correction function is abused.

Therefore, the microprocessor 100 of the embodiment can prevent the unauthorized use of use-restricted application software.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A microprocessor comprising:
a processor core;
a program memory storing application software in a ROM area;
an application information memory including an address range of application software targeted for restriction on use in the program memory;
a yes-or-no information memory including yes-or-no information on use of the application software targeted for restriction on use;
a switch to switch between whether or not to apply an input signal to the processor core; and
a judgment unit to judge whether a program counter value of the processor core is within the address range described in the application information memory and, when the program counter value is within the address range, controls the switching of the switch based on the yes-or-no information written in the yes-or-no information memory.

2. The microprocessor according to claim 1, wherein the judgment unit controls the switch to apply the input signal to the processor core when the yes-or-no information is “YES”, and not to apply the input signal to the processor core when the yes-or-no information is “NO”.

3. The microprocessor according to claim 2, wherein when the yes-or-no information is “NO”, the switch switches the input signal to a ground potential and outputs the ground potential to the processor core.

4. The microprocessor according to claim 1, wherein the application information memory and the yes-or-no information memory are configured to be unrewritable by a user.

5. The microprocessor according to claim 1, wherein the processor core includes a ROM correction function.

6. The microprocessor according to claim 5, wherein the application information memory and the yes-or-no information memory are not influenced by the ROM correction function.

7. The microprocessor according to claim 5, wherein when a ROM correction is performed, program data for modification is stored in a RAM area of the program memory.

8. The microprocessor according to claim 1, wherein application software having a restriction on use and application software having no restriction on use are stored in the ROM area.

9. The microprocessor according to claim 8, wherein one-bit yes-or-no information is provided to the application software having a restriction on use.

10. The microprocessor according to claim 1, wherein when there is a plurality of application software targeted for restriction on use, the yes-or-no information is written in the yes-or-no information memory for each application software.
